(19) United States
(12) Patent Application Publication
(10) Pub. No.: US 2010/0161368 A1
(43) Pub. Date: Jun. 24, 2010

(54) MANAGING ENERGY IN A DATA CENTER

(75) Inventors: Christopher J. Dawson, Arlington, VA (US); Vincenzo V. Diluoffo, Sandy Hook, CT (US); Rick A. Hamilton, II, Charlottesville, VA (US); Michael D. Kendzierski, New York, NY (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/342,344

(22) Filed: Dec. 23, 2008

(51) Int. Cl. G06Q 10/00

(52) U.S. Cl. 705/8

(57) ABSTRACT

An approach that manages energy in a data center is provided. In one embodiment, there is an energy management tool, including an analysis component configured to analyze an operating state of each of a plurality of systems within a data center to determine a set of systems from the plurality of systems within the data center that is currently using energy. The energy management tool further comprises a priority component configured to prioritize a routing of a workload to the set of systems from the plurality of systems within the data center that is currently using energy.

### FIELD OF THE INVENTION

This invention discloses an approach for managing energy. Specifically, the present invention provides a solution for policy-based energy management.

### BACKGROUND OF THE INVENTION

For many companies, the amount of time, money and people required to manage a traditional server cluster in a data center has made managing service availability more difficult. Commodity hardware and virtualization technologies using data center virtualization attempt to reduce traditional energy requirements. Data center virtualization is the process of aligning resources with the needs of services. Virtualization technology enables creation of a set of logical resources that share underlying physical resources. A group of resources, such as servers, applications, databases, and networks, behave as a single resource from which all services are drawn. It requires application components, access software, virtualized operating systems, storage, etc. A key challenge to this has been provisioning and managing these complex environments to ensure cost-effective, efficient service.

### SUMMARY OF THE INVENTION

In one embodiment, there is a method for managing energy in a data center. In this embodiment, the method comprises: analyzing an operating state of each of a plurality of systems within a data center to determine a set of systems from the plurality of systems within the data center that is currently using energy; and prioritizing a routing of a workload to the set of systems from the plurality of systems within the data center that is currently using energy.

In a second embodiment, there is a system for managing energy in a data center. In this embodiment, the system comprises at least one processing unit, and memory operably associated with the at least one processing unit. An energy management tool is storable in memory and executable by the at least one processing unit. The energy management tool comprises: an analyzing component configured to analyze an operating state of each of a plurality of systems within a data center to determine a set of systems from the plurality of systems within the data center that is currently using energy; and a priority component configured to prioritize a routing of a workload to the set of systems from the plurality of systems within the data center that is currently using energy.

In a third embodiment, there is a computer-readable medium storing computer instructions, which when executed, enables a computer system to manage energy in a data center. In this embodiment, the computer instructions comprise: analyzing an operating state of each of a plurality of systems within a data center to determine a set of systems from the plurality of systems within the data center that is currently using energy; and prioritizing a routing of a workload to the set of systems from the plurality of systems within the data center that is currently using energy.

In a fourth embodiment, there is a method for deploying an energy management tool for use in a computer system that provides energy management in a data center. In this embodiment, a computer infrastructure is provided and is operable to: analyze an operating state of each of a plurality of systems within a data center to determine a set of systems from the plurality of systems within the data center that is currently using energy; and prioritize a routing of a workload to the set of systems from the plurality of systems within the data center that is currently using energy.

### BRIEF DESCRIPTION OF THE DRAWINGS

FIG. 1 shows a schematic of an exemplary computing environment in which elements of the present invention may operate;

FIG. 2 shows a more detailed view of an energy management tool that operates in the environment shown in FIG. 1; and

FIG. 3 shows a workflow diagram for prioritizing a routing of a workload using the energy management tool shown in FIGS. 1-2.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to managing energy within a data center to optimize the energy characteristics and improve the overall energy efficiency of the data center. In these embodiments, an energy management tool provides this capability. Specifically, the energy management tool comprises an analysis component configured to analyze an operating state of each of a plurality of systems within a data center to determine a set (i.e., one or more) of systems from the plurality of systems within the data center that is currently using energy, i.e., currently “on” and processing workload, or on and available to receive a workload. A priority component is configured to prioritize a routing of a workload (e.g., a process or group of processes representing a business service or application) to the set of systems from the plurality of systems within the data center that is currently using energy.

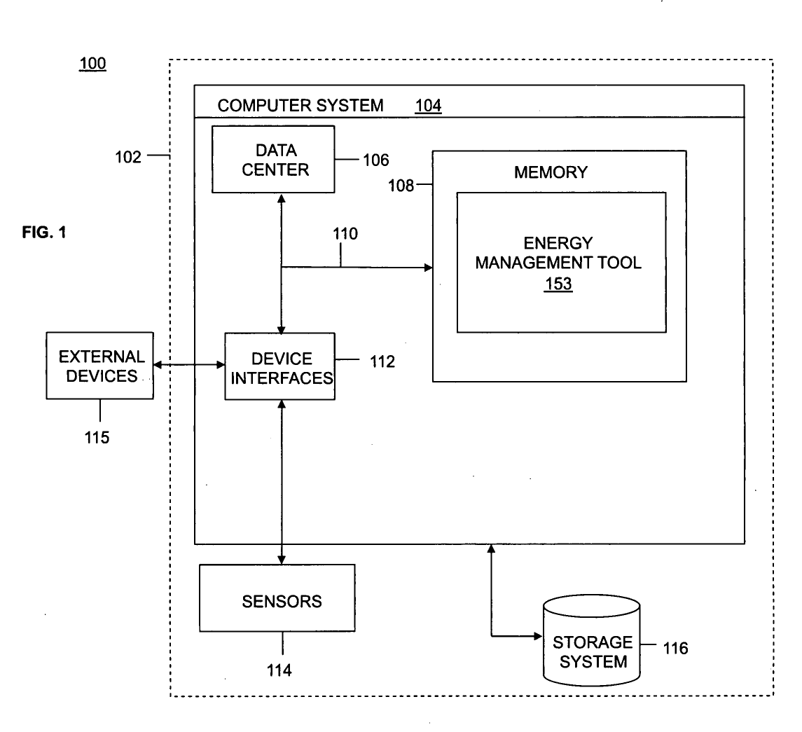

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

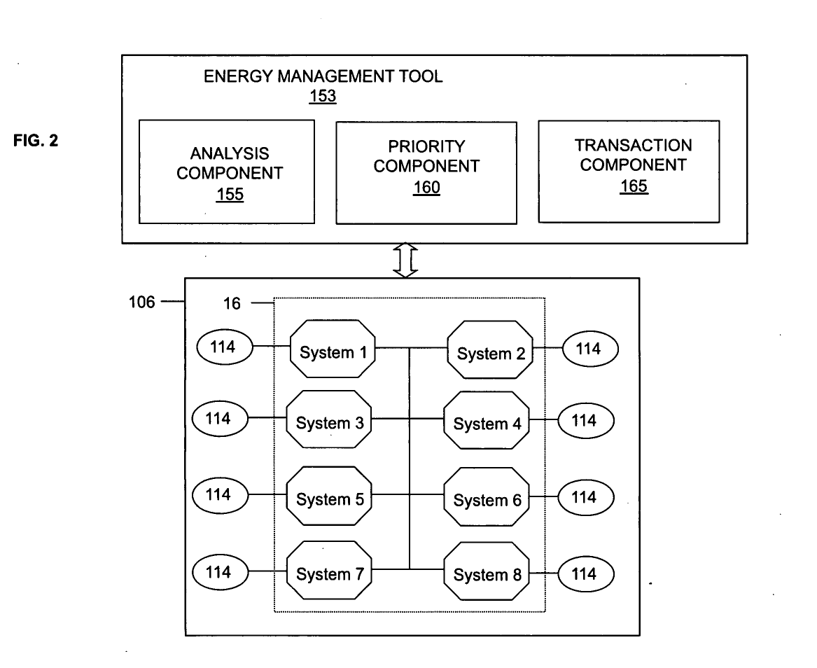

Computer system 104 is intended to represent any type of computer system that may be implemented in deploying/realizing the teachings recited herein. In this particular example, computer system 104 represents an illustrative system for managing energy in a data center. It should be understood that any other computers implemented under the present invention may have different components/software, but will perform similar functions. As shown, computer system 104 includes a data center 106 containing a plurality of systems (e.g., a grid of servers) 16 (FIG. 2), each responsible for managing a portion of data center 106. Also shown is memory 108 for storing an energy management tool 153, a bus 110, and device interfaces 112.

Computer system 104 is shown communicating with a set of sensors 114 that communicate with bus 110 via device interfaces 112. Sensors 114 capture data representing attributes of the environment surrounding each of plurality of systems 16 including, but not limited to: temperature, humidity, airflow, carbon emissions, etc. Sensors 114 can include any type of sensor capable of capturing environmental attributes within data center 106.

Data center 106 collects and routes signals representing outputs from sensors 114 to energy management tool 153. The signals can be transmitted over a LAN and/or a WAN (e.g., T1, T3, 56 kb, X.25), broadband connections (ISDN, Frame Relay, ATM), wireless links (802.11, Bluetooth, etc.), and so on. Different sensor systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)). In some embodiments, sensors 114 are capable of two-way communication, and thus can receive signals (to power up, to sound an alert, etc.) from energy management tool 153.

While executing computer program code, data center 106 can read and/or write data to/from memory 108 and storage system 116. Storage system 116 can store can store virtually any type of environmental or system data, such as sensor data from sensors 114. Storage system 116 can include VCRs, DVRs, RAID arrays, USB hard drives, optical disk recorders, flash storage devices, image analysis devices, general purpose computers, video enhancement devices, de-interlacers, scalers, and/or other data processing and storage elements.

Although not shown, computer system 104 could also include I/O interfaces that communicate with one or more external devices 115 that enable a user to interact with computer system 104 (e.g., a keyboard, a pointing device, a display, etc.).

FIG. 2 shows a more detailed view of energy management tool 153 according to embodiments of the invention. As will be described in the exemplary embodiment herein, energy management tool 153, in combination with implementation 100, is configured to route a workload(s) to the systems within data center 106 that are currently using energy, such as systems that are currently processing workload(s), or systems that are on and available. Workloads may be sent to systems that are already consuming energy such that systems, networks and storage components that are currently in hibernation, spun-down or otherwise “off” may remain in that state. This helps maximize the energy efficiency of data center 106 and reduces the energy usage of the overall implementation.

To accomplish this, the energy characteristics of each of plurality of systems 16 must be examined. As shown in FIG. 2, energy management tool 153 comprises an analysis component 155 configured to analyze an operating state of each of plurality of systems 16 within data center 106 to determine a set of systems from plurality of systems 16 within data center 106 that is currently using energy. Based on the analysis, a priority component 160 (e.g., a workload balancer) is configured to prioritize a routing of a workload to the set of systems from plurality of systems 16 within data center 106 that is currently using/consuming energy.

In one embodiment, analysis component 155 analyzes the operating state of each of plurality of systems 16 within data center 106 to determine which of the systems are currently operating, as well as the current workload usage of each system within data center 106. For example, each of plurality of systems 16 may be identified as being in a variety of operating states, from 0-7, as follows:
(0) would signify that the infrastructure system is off, or there is an error processing workload;
(1) would indicate that the system is online but running in hibernation mode;
(2) would indicate that the system is on but not currently processing any workload;
(3) would indicate that the system is not processing any workload, but is online and available to process workload; and
(4) to (7) would indicate the current level of workload usage of the system, wherein (7) indicates a relatively high level of workload usage.
   Priority component 160 uses these operating states to determine the relative priority between each of plurality of systems 16, as will be further described below. The above operating state designation represents one non-limiting example. It will be appreciated that other gradients could likewise be defined, such that higher or lower order states (i.e., more or fewer conditions) could similarly be employed while still keeping within the scope of the present invention.

In one embodiment, energy management tool 153 routes workload to systems that may be more viable targets for consuming less energy, and away from systems that may be in zones within data center 106 that are relatively hot or are already operating at a specified threshold for energy use. To accomplish this, analysis component 155 is configured to receive environmental sensor data associated with each of plurality of systems 16 within data center 106. The environmental data can be collected by sensors 114 at predetermined or dynamically determined time intervals. Analysis component 155 then determines an energy profile of each of plurality of systems 16 based on this collected environmental data. The energy profile comprises data regarding at least one of the following: temperature, humidity, airflow, future workload requirements, application priorities, location of each of the plurality of systems within the data center, or time of day, etc. This energy profile is sent to priority component 160 where it used to determine weights for the workload and/or workload job scheduling. Based on this energy profile, as well as the operating states and current workload usage of each of plurality of systems 16, priority component 160 prioritizes the routing of the workload within data center 106. Specifically, priority component 160 optimizes energy management within data center 106 by routing the workload to those systems that are currently “on” and operating within an acceptable (i.e., low) temperature and current workload usage range, which may be predefined, or dynamically updated as system and environmental factors change.

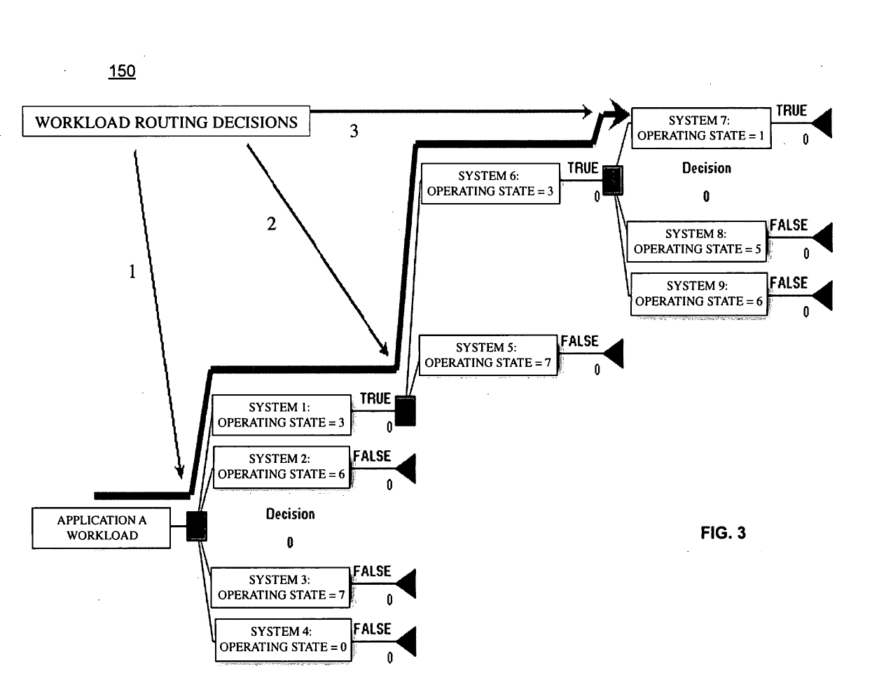

Referring now to FIG. 3, the present invention will be described in the context of the following workflow model 150. In this example, environmental, operating, and usage data is collected from systems 1-8 and used to build workflow model 150, which demonstrates an optimized job workload and/or schedule for a workload of Application A (e.g., e-mail). As shown, at workload routing decision 1, the operating states of systems 1-4 are analyzed. System 1 has an operating state of “3,” indicating that the system is not currently processing any workload, but is online and available to. As shown, systems 2-3 have operating states of “6” and “7,” respectively, indicating that they are currently processing a relatively high workload level. System 4 has an operating state of “0,” indicating it is currently powered down in an “off” state. Based on the operating states of systems 1-4, Application A workload is routed to system 1. The same process is performed at decision points 2 and 3 based on the various operating states of systems 5-9. As shown, system 1, system 6 and system 7 participate in the workload due to their low utilization and the requirement to avoid systems that are off or running at maximum capacity. After the workload for Application A is routed, process flow 150 is repeated for the next application. It will be appreciated that this workflow represents one possible workflow for prioritizing the routing of a workload, and that other approaches are possible within the scope of the present invention.

As described herein, the present invention allows for the management of energy within a data center by running an application workload in the most optimal location based on environmental and system variables. The present invention prioritizes the routing of workload jobs to systems within an infrastructure that are already “on” and running, rather than having to switch on or spin up systems that would otherwise remain off. As such, energy efficiency and energy costs within data center 106 are optimized.

In another embodiment of this invention, energy management tool 153 is used as a service to charge fees managing energy in the data center. Specifically, energy management tool 153 comprises a transaction component 165 configured to charge a management fee for the management of energy within data center 106. For example, a data center operator or a third party service provider could offer this energy management as a service by performing the functionalities described herein on a subscription and/or fee basis.

Further, it can be appreciated that the methodologies disclosed herein can be used within a computer system to manage energy, as shown in FIG. 1. In this case, energy management tool 153 can be provided, and one or more systems for performing the processes described in the invention can be obtained and deployed to computer infrastructure 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

Furthermore, an implementation of exemplary computer system 104 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for managing energy within a data center. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for managing energy in a data center comprising:
analyzing an operating state of each of a plurality of systems within a data center to determine a set of systems from the plurality of systems within the data center that is currently using energy; and
prioritizing a routing of a workload to the set of systems from the plurality of systems within the data center that is currently using energy.

2. The method according to claim 1, the analyzing further comprising analyzing the operating state of each of the plurality of systems within the data center to determine a current workload usage of each of the plurality of systems within the data center.

3. The method according to claim 2, the analyzing further comprising analyzing environmental conditions surrounding each of the plurality of systems within the data center to determine an energy profile of each of the plurality of systems within the data center.

4. The method according to claim 3, the prioritizing further comprising prioritizing the routing of the workload to the set of systems from the plurality of systems within the data center based on the current workload usage of each of the plurality of systems within the data center and the energy profile of each of the plurality of systems within the data center.

5. The method according to claim 3, wherein the energy profile comprises data regarding at least one of the following: temperature, humidity, airflow, future workload requirements, application priorities, location of each of the plurality of systems within the data center, or time of day.

6. The method according to claim 1 further comprising charging a management fee for the management of energy in the data center.

7. A system for managing energy in a data center comprising:
at least one processing unit;
memory operably associated with the at least one processing unit; and
an energy management tool storable in memory and executable by the at least one processing unit, the energy management tool comprising:
an analysis component configured to analyze an operating state of each of a plurality of systems within a data center to determine a set of systems from the plurality of systems within the data center that is currently using energy; and
a priority component configured to prioritize a routing of a workload to the set of systems from the plurality of systems within the data center that is currently using energy.

8. The energy management tool according to claim 7, the analysis component further configured to analyze the operating state of each of the plurality of systems within the data center to determine a current workload usage of each of the plurality of systems within the data center.

9. The energy management tool according to claim 8, the analysis component further configured to analyze the environmental conditions surrounding each of the plurality of systems within the data center to determine an energy profile of each of the plurality of systems within the data center.

10. The energy management tool according to claim 9, the priority component further configured to prioritize the routing of the workload to the set of systems from the plurality of systems within the data center based on the current workload usage of each of the plurality of systems within the data center and the energy profile of each of the plurality of systems within the data center.

11. The energy management tool according to claim 9, wherein the energy profile comprises data regarding at least one of the following: temperature, humidity, airflow, future workload requirements, application priorities, location of each of the plurality of systems within the data center, or time of day.

12. The energy management tool according to claim 7 further comprising a transaction component configured to charge a management fee for the management of energy in the data center.

13. A computer-readable medium storing computer instructions, which when executed, enables a computer system to manage energy in a data center, the computer instructions comprising:
analyzing an operating state of each of a plurality of systems within a data center to determine a set of systems from the plurality of systems within the data center that is currently using energy; and
prioritizing a routing of a workload to the set of systems from the plurality of systems within the data center that is currently using energy.

14. The computer-readable medium according to claim 13 further comprising computer instructions for analyzing the operating state of each of the plurality of systems within the data center to determine a current workload usage of each of the plurality of systems within the data center.

15. The computer-readable medium according to claim 14 further comprising computer instructions for analyzing environmental conditions surrounding each of the plurality of systems within the data center to determine an energy profile of each of the plurality of systems within the data center.

16. The computer-readable medium according to claim 15 further comprising computer instructions for prioritizing the routing of the workload to the set of systems from the plurality of systems within the data center based on the current workload usage of each of the plurality of systems within the data center and the energy profile of each of the plurality of systems within the data center.

17. The computer-readable medium according to claim 15, wherein the energy profile comprises data regarding at least one of the following: temperature, humidity, airflow, future workload requirements, application priorities, location of each of the plurality of systems within the data center, or time of day.

18. The computer-readable medium according to claim 13 further comprising computer instructions for charging a management fee for the management of energy in the data center.

19. A method for deploying an energy management tool for use in a computer system that provides energy management in a data center, comprising:
providing a computer infrastructure operable to:
analyze an operating state of each of a plurality of systems within a data center to determine a set of systems from the plurality of systems within the data center that is currently using energy; and
prioritize a routing of a workload to the set of systems from the plurality of systems within the data center that is currently using energy.

20. The method according to claim 19, the computer infrastructure further operable to analyze the operating state of each of the plurality of systems within the data center to determine a current workload usage of each of the plurality of systems within the data center.

21. The method according to claim 20, the computer infrastructure further operable to analyze environmental conditions surrounding each of the plurality of systems within the data center to determine an energy profile of each of the plurality of systems within the data center.

22. The method according to claim 21, the computer infrastructure further operable to prioritize the routing of the workload to the set of systems from the plurality of systems within the data center based on the current workload usage of each of the plurality of systems within the data center and the energy profile of each of the plurality of systems within the data center.

23. The method according to claim 21, wherein the energy profile comprises data regarding at least one of the following: temperature, humidity, airflow, future workload requirements, application priorities, location of each of the plurality of systems within the data center, or time of day.

24. The method according to claim 19, the computer infrastructure further operable to charge a management fee for the management of energy in the data center.
